(19) United States
(12) Patent Application Publication
(10) Pub. No.: US 2024/0162957 A1
(43) Pub. Date: May 16, 2024

(54) METHOD AND DEVICE FOR REPORTING CSI BASED ON AI MODEL IN WIRELESS COMMUNICATION SYSTEM

(71) Applicant: Samsung Electronics Co., Ltd., Gyeonggi-do (KR)

(72) Inventors: Wonjun KIM, Gyeonggi-do (KR); Suhwook KIM, Gyeonggi-do (KR); Deokhui LEE, Gyeonggi-do (KR); Juho LEE, Gyeonggi-do (KR); Jungsoo JUNG, Gyeonggi-do (KR)

(21) Appl. No.: 18/495,212

(22) Filed: Oct. 26, 2023

(30) Foreign Application Priority Data
Nov. 3, 2022 (KR) 10-2022-0145143

(51) Int. Cl. H04B 7/06; H04W 24/02

(52) U.S. Cl. CPC H04B 7/0626; H04B 7/0645; H04W 24/02

(57) ABSTRACT

The present disclosure relates to a fifth generation (5G) communication system or a sixth generation (6G) communication system for supporting higher data rates beyond a 4G communication system such as long term evolution (LTE). A method performed by a user equipment (UE) in a wireless communication system may include transmitting, to a base station, an artificial intelligence (AI)-based channel state information (CSI) feedback mode supported by an AI model of the UE and capability information corresponding to the CSI feedback mode, the AI-based CSI feedback mode including at least one of an AI-based channel prediction mode or an AI-based CSI compression mode, receiving, from the base station, an indicator indicating the CSI feedback mode performed by the UE and configuration information corresponding to the CSI feedback mode performed by the UE, generating CSI, based on the received configuration information and a CSI-reference signal (CSI-RS), and transmitting the generated CSI to the base station.

### CROSS-REFERENCE TO RELATED APPLICATION(S)

This application is based on and claims priority under 35 U.S.C. § 119 to Korean Patent Application No. 10-2022-0145143, filed in the Korean Intellectual Property Office on Nov. 3, 2022, the disclosure of which is incorporated herein by reference in its entirety.

### BACKGROUND

### 1. Field

The disclosure relates generally to a wireless communication system and, more specifically, to a method and a device for reporting channel state information (CSI) through channel prediction and CSI compression based on an artificial intelligence (AI) model in a wireless communication system.

### 2. Description of Related Art

Given the expansive development of wireless communication over the years, technologies have been developed mainly for services targeting humans, such as voice calls, multimedia services, and data services. Following the commercialization of the 5th generation (5G) communication systems, it is expected that the number of connected devices will exponentially increase. These devices will be connected to communication networks and may include vehicles, robots, drones, home appliances, displays, smart sensors connected to various infrastructures, construction machines, and factory equipment. Mobile devices are expected to evolve in various forms, such as augmented reality glasses, virtual reality headsets, and hologram devices. To provide various services by connecting hundreds of billions of devices and things in the 6th generation (6G) era, there have been ongoing efforts to develop improved 6G communication systems, which are referred to as beyond-5G systems.

6G communication systems, which are expected to be commercialized around 2030, will have a peak data rate of terahertz (THz) (1,000 gigahertz)-level bit per second (bps) and a radio latency less than 100 microseconds (100 μsec), and thus will be 50 times as fast as 5G communication systems and will have 1/10 of the radio latency as in 5G.

To accomplish such a high data rate and an ultra-low latency, it has been considered to implement 6G communication systems in a THz band (for example, 95 gigahertz (GHz) to 3 THz bands). It is expected that, due to more severe path loss and atmospheric absorption in the THz bands than those in millimeter wave (mmWave) bands introduced in 5G, technologies capable of securing the signal transmission distance (that is, coverage) will become more crucial. It is necessary to develop, as major technologies for securing the coverage, radio frequency (RF) elements, antennas, novel waveforms having a better coverage than orthogonal frequency division multiplexing (OFDM), beamforming and massive multiple-input multiple-output (MIMO), full dimensional MIMO (FD-MIMO), array antennas, and multiantenna transmission technologies such as large-scale antennas. In addition, there has been ongoing discussion on new technologies for improving the coverage of THz-band signals, such as metamaterial-based lenses and antennas, orbital angular momentum (OAM), and reconfigurable intelligent surface (RIS).

Moreover, to improve the spectral efficiency and the overall network performances, the following technologies have been developed for 6G communication systems: a full-duplex technology for enabling an uplink transmission and a downlink transmission to simultaneously use the same frequency resource at the same time; a network technology for utilizing satellites, high-altitude platform stations (HAPS), and the like in an integrated manner, an improved network structure for supporting mobile base stations and the like and enabling network operation optimization and automation and the like, a dynamic spectrum sharing technology via collision avoidance based on a prediction of spectrum usage, an use of AI in wireless communication for improvement of overall network operation by utilizing AI from a designing phase for developing 6G and internalizing end-to-end AI support functions, and a next-generation distributed computing technology for overcoming the limit of UE computing ability through reachable super-high-performance communication and computing resources (such as mobile edge computing (MEC), clouds, etc.) over the network. In addition, through designing new protocols to be used in 6G communication systems, developing mechanisms for implementing a hardware-based security environment and safe use of data, and developing technologies for maintaining privacy, attempts to strengthen the connectivity between devices, optimize the network, promote softwarization of network entities, and increase the openness of wireless communications are continuing.

It is expected that research and development of 6G communication systems in hyper-connectivity, including person to machine (P2M) as well as machine to machine (M2M), will enable the next hyper-connected experience. Particularly, it is expected that services such as truly immersive extended reality (XR), high-fidelity mobile hologram, and digital replica will be provided through 6G communication systems. In addition, services such as remote surgery for security and reliability enhancement, industrial automation, and emergency response will be provided through the 6G communication system such that the technologies could be applied in various fields such as industry, medical care, automobiles, and home appliances.

In a wireless communication system, channel state information (CSI) may be used to measure a state of a channel between a user equipment (UE) and a base station. In this case, an AI model may be used to reduce overhead of a reference signal for CSI measurement and more effectively report CSI. Accordingly, a method for reporting CSI through channel prediction and CSI compression based on an AI model is being considered.

In the conventional art, however, the base station predicts a channel based on a discrete value. Thus, it is difficult to accurately reflect channel variation in the conventional art. For example, when channel variation is large, predicted information such as channel quality information, a rank indicator, and a precoding matrix indicator (PMI) may be measured differently according to the channel variation, and thus the accuracy of performing channel prediction may be compromised compared to that of the AI model of the terminal.

Therefore, there is a need in the art for a channel prediction that overcomes the inaccuracies of such channel prediction in the conventional art.

### SUMMARY

The disclosure has been made to address at least the above-mentioned problems and/or disadvantages and to provide at least the advantages described below.

Accordingly, an aspect of the disclosure is to provide a device and a method capable of effectively providing a service in a wireless communication system.

Another aspect of the disclosure is to provide a method and apparatus for providing a reliable and accurate channel prediction in the wireless communication system.

In accordance with an aspect of the disclosure, a method performed by a UE in a wireless communication system includes transmitting, to a base station, an AI-based CSI feedback mode supported by an AI model of the UE and capability information corresponding to the CSI feedback mode, the AI-based CSI feedback mode including at least one of an AI-based channel prediction mode or an AI-based CSI compression mode, receiving, from the base station, an indicator indicating the CSI feedback mode performed by the UE and configuration information corresponding to the CSI feedback mode performed by the UE, generating CSI, based on the received configuration information and a CSI-reference signal (CSI-RS), and transmitting the generated CSI to the base station.

In accordance with an aspect of the disclosure, a method performed by a base station in a wireless communication system includes receiving, from a UE, an AI-based CSI feedback mode supported by an AI model of the UE and capability information corresponding to the CSI feedback mode, the AI-based CSI feedback mode including at least one of an AI-based channel prediction mode or an AI-based CSI compression mode, identifying an indicator indicating a CSI feedback mode performed by the UE and configuration information corresponding to the CSI feedback mode performed by the UE, based on the received capability information, transmitting, to the UE, the indicator indicating the CSI feedback mode performed by the UE and the configuration information corresponding to the CSI feedback mode performed by the UE, and receiving, from the UE, CSI generated based on the transmitted configuration information and a CSI-RS.

In accordance with an aspect of the disclosure, a UE in a wireless communication system includes a transceiver, and a controller coupled to the transceiver, and configured to transmit, to a base station, an AI-based CSI feedback mode supported by an AI model of the UE and capability information corresponding to the CSI feedback mode, the AI-based CSI feedback mode including at least one of an AI-based channel prediction mode or an AI-based CSI compression mode, receive, from the base station, an indicator indicating a CSI feedback mode performed by the UE and configuration information corresponding to the CSI feedback mode performed by the UE, generate CSI, based on the received configuration information and a CSI-RS, and transmit the generated CSI to the base station.

In accordance with an aspect of the disclosure, a base station in a wireless communication system includes a transceiver, and a controller coupled to the transceiver, and configured to receive, from a UE, an AI-based CSI feedback mode supported by an AI model of the UE and capability information corresponding to the CSI feedback mode, the AI-based CSI feedback mode including at least one of an AI-based channel prediction mode or an AI-based CSI compression mode, identify an indicator indicating a CSI feedback mode performed by the UE and configuration information corresponding to the CSI feedback mode performed by the UE, based on the received capability information, transmit, to the UE, the indicator indicating the CSI feedback mode performed by the UE and the configuration information corresponding to the CSI feedback mode performed by the UE, and receive, from the UE, CSI generated based on the transmitted configuration information and a CSI-RS.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a wireless communication environment according to an embodiment;

FIG. 2 illustrates a configuration of a base station in a wireless communication system according to an embodiment;

FIG. 3 illustrates a configuration of a UE in a wireless communication system according to an embodiment;

FIG. 4 illustrates a process of reporting CSI by using an AI model in a wireless communication system according to an embodiment;

FIG. 5 illustrates a process of performing channel prediction and CSI compression using an AI model in a wireless communication system according to an embodiment;

FIG. 6 illustrates a timeline in which CSI feedback is performed according to channel prediction using an AI model according to an embodiment;

FIG. 7 illustrates a signal flow for channel prediction and CSI compression using an AI model according to an embodiment;

FIG. 8 illustrates a signal flow for channel prediction using an AI model according to an embodiment;

FIG. 9 illustrates a signal flow for CSI compression using an AI model according to an embodiment;

FIG. 10A illustrates a signal flow for combined execution of CSI compression and channel prediction using an AI model according to an embodiment;

FIG. 10B illustrates an independent or combined execution of CSI compression and channel prediction using an AI model according to an embodiment;

FIG. 11 illustrates a method of a UE for channel prediction and CSI compression using an AI model according to an embodiment; and

FIG. 12 illustrates a method of a base station for channel prediction and CSI compression using an AI model according to an embodiment.

### DETAILED DESCRIPTION

Hereinafter, embodiments of the disclosure are described in detail with reference to the accompanying drawings. Descriptions of well-known functions and constructions may be omitted for the sake of clarity and conciseness.

The terms used in the disclosure are only used to describe specific embodiments, and are not intended to limit the disclosure. A singular expression may include a plural expression unless they are definitely different in a context. Unless defined otherwise, all terms used herein, including technical and scientific terms, have the same meaning as those commonly understood by a person skilled in the art to which the disclosure pertains. Such terms as those defined in a generally used dictionary may be interpreted to have the meanings equal to the contextual meanings in the relevant field of art, and are not to be interpreted to have ideal or excessively formal meanings unless clearly defined in the disclosure. In some cases, even the term defined in the disclosure should not be interpreted to exclude embodiments of the disclosure.

Hereinafter, embodiments of the disclosure will be described based on an approach of hardware, but may also include a technology that uses both hardware and software. Thus, the various embodiments of the disclosure may not exclude the perspective of software.

An element included in the disclosure is expressed in the singular or the plural according to the embodiment. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

In the following description, terms referring to device elements (e.g., control unit, processor, AI model, encoder, decoder, autoencoder (AE), and neural network (NN) model) and to data (e.g., signal, feedback, report, reporting, information, parameter, value, bit, and codeword) are illustratively used for the sake of descriptive convenience. Therefore, the disclosure is not limited by the terms as used below, and other terms having equivalent technical meanings may be used.

Embodiments will be described using terms employed in some communication standards (e.g., the 3rd generation partnership project (3GPP)), but these are only for the sake of illustration. Embodiments may also be applied to other communication systems through modifications.

Herein, names and contents of the described information or parameters are only examples, but the disclosure is not limited thereto, and information or parameters for performing functions similar or substantially identical thereto may be used. In addition, the respective operations may be performed independently or in combination, and are not limited to essential configurations for the embodiments of the disclosure.

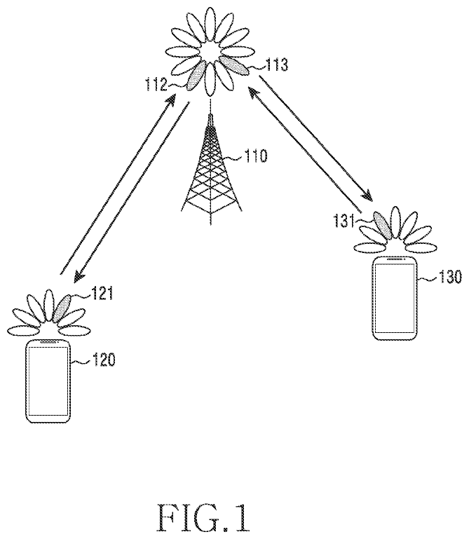

FIG. 1 illustrates a wireless communication system according to an embodiment. Specifically, FIG. 1 illustrates a base station 110, a terminal 120, and a terminal 130 as some of nodes using a wireless channel in a wireless communication system. Although FIG. 1 illustrates only one base station, another base station equal or similar to the base station 110 may be further included.

The base station 110 is a network infrastructure which provides wireless access to the terminals 120 and 130 and has coverage defined as a predetermined geographical area, based on the distance over which a signal can be transmitted. The base station 110 may also be referred to as an access point (AP), an eNodeB (eNB), a gNodeB (gNB), a 5G node, a 6G node, a wireless point, a transmission/reception point (TRP), or another term having an equivalent technical meaning.

Each of the terminal 120 and terminal 130 is used by a user and communicates with the base station 110 through a wireless channel. In some cases, at least one of the terminal 120 and the terminal 130 may be operated without user involvement. That is, at least one of the terminal 120 and the terminal 130 is a device which performs machine type communication (MTC) and may not be carried by a user. Each of the terminal 120 and terminal 130 may also be referred to as a UE, a mobile station, a subscriber station, a customer premises equipment (CPE), a remote terminal, a wireless terminal, an electronic device, a user device, or another term having an equivalent technical meaning.

The base station 110, the terminal 120, and the terminal 130 may transmit and receive a wireless signal in a mmWave band (e.g., 28 GHz, 30 GHz, 38 GHz, 60 GHz, over 60 GHz, etc.). In this case, to improve a channel gain, the base station 110, the terminal 120, and the terminal 130 may perform beamforming. The beamforming may include transmission beamforming and reception beamforming That is, the base station 110, the terminal 120, and the terminal 130 may give directivity to a transmission signal or a reception signal. To this end, the base station 110 and the terminals 120 and 130 may select serving beams 112, 113, 121, and 131 through a beam search or beam management procedure. After the serving beams 112, 113, 121, and 131 are selected, communication may be performed through a resource having a quasi co-located (QCL) relationship with a resource having transmitted the serving beams 112, 113, 121, and 131.

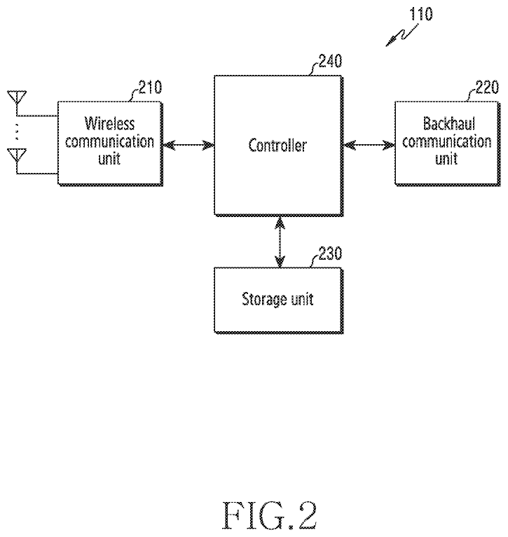

FIG. 2 illustrates a configuration of a base station in a wireless communication system according to an embodiment. The base station 110 may be referred to as a network for convenience. The configuration illustrated in FIG. 2 may be understood as the configuration of the base station 110. The term “ . . . unit”, “-er”, or the like used hereinafter may indicate a unit entity which processes at least one function or operation, and which may be implemented by hardware, software, or a combination of hardware and software.

Referring to FIG. 2, the base station 110 may include a wireless communication unit 210, a backhaul communication unit 220, a storage unit 230, and a controller 240.

The wireless communication unit 210 performs functions for transmitting or receiving a signal through a wireless channel. For example, the wireless communication unit 210 performs a conversion function between a baseband signal and a bit stream according to a physical layer standard of a system. At the time of data transmission, the wireless communication unit 210 generates complex symbols by encoding and modulating transmission bit streams. At the time of data reception, the wireless communication unit 210 restores a reception bit stream through demodulation and decoding of a baseband signal. The wireless communication unit 210 up-converts a baseband signal into a RF signal and then transmits the RF band signal through an antenna, and down-converts the RF band signal received through the antenna into the baseband signal.

To this end, the wireless communication unit 210 may include a transmission filter, a reception filter, an amplifier, a mixer, an oscillator, a digital to analog convertor (DAC), an analog to digital convertor (ADC), a plurality of transmission/reception paths, and at least one antenna array including a plurality of antenna elements. In terms of hardware, the wireless communication unit 210 may include a digital unit and an analog unit, and the analog unit may include a plurality of sub-units, based on operation power, operation frequency, etc.

The wireless communication unit 210 may transmit or receive a signal and thus, may include at least one transceiver. For example, the wireless communication unit 210 may transmit a synchronization signal, a reference signal, system information, a message, control information, or data, and may perform beamforming.

The wireless communication unit 210 transmits and receives a signal as described above. Accordingly, all or a part of the wireless communication unit 210 may be referred to as a transmitter, a receiver, or a transceiver. In addition, transmission and reception performed through a wireless channel herein refers to the processing described above performed by the wireless communication unit 210.

The backhaul communication unit 220 provides an interface for communicating with other nodes in the network. That is, the backhaul communication unit 220 converts a bit stream transmitted from the base station 110 to another access node, another base station, an upper node, a core network, etc. into a physical signal, and converts a physical signal received from the another node into a bit stream.

The storage unit 230 stores data such as a basic program, an application program, and configuration information for the operation of the base station 110. The storage unit 230 may include a volatile memory, a non-volatile memory, or a combination of the volatile memory and the non-volatile memory. In addition, the storage unit 230 provides stored data in response to a request of the controller 240 and may store learning data for an AI-based CSI report and apply the stored learning data to a neural network structure of the AI-based CSI report.

The controller 240 controls the overall operations of the base station 110. For example, the controller 240 transmits and receives a signal through the wireless communication unit 210 or the backhaul communication unit 220, records and reads data on and from the storage unit 230, and may perform functions of a protocol stack required by communication standards. To this end, the controller 240 may include at least one processor.

The configuration of the base station 110 shown in FIG. 2 is not limited to the configuration shown in FIG. 2. That is, some configurations may be added, deleted, or changed.

Although the base station is described as one entity in FIG. 2, the disclosure is not limited thereto. A base station herein may be implemented to form an access network having a distributed deployment as well as an integrated deployment. The base station may be divided into a central unit (CU) and a digital unit (DU) so that the CU may be implemented to perform upper layer functions (e.g., a radio link control (RLC), a packet data convergence protocol (PDCP), and a radio resource control (RRC)) and the DU may be implemented to perform lower layer functions (e.g., a medium access control (MAC) and a physical (PHY)). The DU of the base station may form beam coverage on a wireless channel.

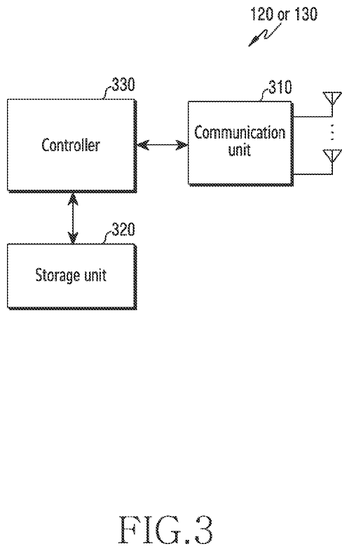

FIG. 3 illustrates a configuration of a UE in a wireless communication system according to an embodiment.

Referring to FIG. 3, the terminals 120 and 130 may include a communication unit 310, a storage unit 320, and a controller 330.

The communication unit 310 performs functions for transmitting or receiving a signal through a wireless channel. For example, the communication unit 310 performs a conversion function between a baseband signal and a bit stream according to a physical layer standard of a system. At the time of data transmission, the communication unit 310 generates complex symbols by encoding and modulating transmission bit streams. At the time of data reception, the communication unit 310 restores a reception bit stream through demodulation and decoding of a baseband signal. The communication unit 310 up-converts a baseband signal into a RF signal and then transmits the RF band signal through an antenna, and down-converts the RF band signal received through the antenna into the baseband signal. For example, the communication unit 310 may include a transmission filter, a reception filter, an amplifier, a mixer, an oscillator, a DAC, an ADC, etc.

The communication unit 310 may include a plurality of transmission/reception paths and an antenna unit including at least one antenna array including a plurality of antenna elements. In terms of hardware, the communication unit 310 may include a digital circuit and an analog circuit (e.g., a radio frequency integrated circuit (RFIC)). The digital circuit and the analog circuit may be implemented in one package. In addition, the communication unit 310 may include a plurality of RF chains. The communication unit 310 may perform beamforming. To give directionality according to configuration of the controller 330 to a signal to be transmitted or received, the communication unit 310 may apply a beamforming weight to the signal. The communication unit 310 may include an RF block (or RF unit) including a first RF circuitry related to an antenna and a second RF circuitry related to baseband processing. The first RF circuitry may be referred to as an RF-A (antenna). The second RF circuitry may be referred to as an RF-B (baseband).

The communication unit 310 may transmit or receive a signal and thus, may include at least one transceiver. The communication unit 310 may receive a downlink signal including a synchronization signal (SS), a reference signal (RS) (e.g., a cell-specific reference signal (CRS) and demodulation (DM)-RS), system information (e.g., MIB, SIB, remaining system information (RMSI), and other system information (OSI)), a configuration message, control information, downlink data, etc. The communication unit 310 may transmit an uplink signal including a random access related signal (e.g., a random access preamble (RAP) (or message 1 (Msg1) or message 3 (Msg3)), a reference signal (e.g., a sounding reference signal (SRS) or DM-RS), or a power headroom report (PHR).

In addition, the communication unit 310 may include different communication modules to process signals of different frequency bands and a plurality of communication modules to support a plurality of different wireless access technologies. For example, the different wireless access technologies may include Bluetooth™ low energy (BLE), wireless fidelity (Wi-Fi), WiFi gigabyte (WiGig), a cellular network (e.g., long term evolution (LTE) or new radio (NR)), etc. The different frequency bands may include a super high frequency (SHF) (e.g., 2.5 GHz and 5 Ghz) band and an mmwave (e.g., 38 GHz, 60 GHz, etc.) band. In addition, the communication unit 310 may use a wireless access technology in the same manner on different frequency bands (e.g., an unlicensed band for licensed assisted access (LAA) and citizens broadband radio service (CBRS) (e.g., 3.5 GHz)).

The communication unit 310 transmits and receives a signal as described above. Accordingly, all or a part of the communication unit 310 may be referred to as a transmitter, a receiver, or a transceiver. In addition, in the following description, transmission and reception performed through a wireless channel refers to the processing described above performed by the communication unit 310.

The storage unit 320 stores data such as a basic program, an application program, and configuration information for the operation of the terminal 120. The storage unit 320 may include a volatile memory, a non-volatile memory, or a combination of the volatile memory and the non-volatile memory. In addition, the storage unit 320 provides stored data in response to a request of the controller 330 and may store learning data for an AI-based CSI report according to CSI configuration configured by the base station.

The controller 330 controls the overall operations of the terminals 120 and 130. For example, the controller 330 transmits and receives a signal through the communication unit 310, records and reads data on and from the storage unit 320, and may perform functions of a protocol stack required by communication standards. To this end, the controller 330 may include at least one processor or microprocessor, or may be a part of the processor. A part of the communication unit 310 and the controller 330 may be referred to as a cellular processor (CP). The controller 330 may include various modules for performing communication and may control the terminal to perform operations according to various embodiments.

An AI model trained based on the neural network may be operated through the controller 330 and the storage unit 320. In this case, the controller 330 may include one or a plurality of processors. The one or plurality of processors may include functions of general-purpose processors such as a CPU, an application processor, and a digital signal processor (DSP), graphics-only processors such as a graphics processing unit (GPU) and a vision processing unit (VPU), or an AI-dedicated processor such as an NPU. The one or plurality of processors may control input data to be processed, based on an AI model or a predefined operation rule stored in the storage unit 320. Alternatively, when the one or plurality of processors are AI-dedicated processors, the AI-dedicated processors may be designed to have a hardware structure specialized for processing a specific AI model. The AI-dedicated processor is not included in the controller 330 and may be included as a separate configuration.

The predefined operation rule or the AI model is characterized by having been made through learning. The expression “made through learning” implies that a basic AI model is trained using a plurality of learning data by a learning algorithm, so that the predefined operation rule or the AI model configured to perform a desired characteristic (or purpose) is made. Such learning may be performed in a device itself in which AI is performed according to the disclosure, or may be performed through a separate server and/or system. A learning algorithm includes supervised learning, unsupervised learning, semi-supervised learning, or reinforcement learning, but is not limited to the above example. The controller 330 may learn an occurring event, a determined determination, and collected or input information through a learning algorithm. The controller 330 may store a result of the learning in the storage unit 320 (e.g., a memory).

The AI model may include a plurality of neural network layers having a plurality of weight values, and a neural network operation is performed through an operation between the plurality of weight values and an operation result of a previous layer. The plurality of weight values possessed by the plurality of neural network layers may be optimized by a learning result of the AI model. For example, the plurality of weight values may be updated so that a loss value or a cost value obtained from the AI model is reduced or minimized during a learning process. The artificial neural network may include a deep neural network (DNN), such as a convolutional neural network (CNN), deep neural network (DNN), recurrent neural network (RNN), restricted Boltzmann machine (RBM), deep belief network (DBN), bidirectional recurrent deep neural network (BRDNN), long short term memory (LSTM), or deep Q-Networks, but is not limited to the above examples.

The controller 330 may execute an algorithm for performing an operation related to an AI-based CSI report or feedback. An AI model trained to perform the operation related to the AI-based CSI feedback may be configured as hardware, included as software, or configured through a combination of hardware and software in the controller 330. In other words, the controller 330 may include an AI-based CSI feedback controller. The AI-based CSI feedback controller may perform prediction for an AI-based channel, identification of prediction performance for each channel, determination of whether to report a result of the identification, and determination of whether to use AI-based CSI feedback. In addition, the controller 330 may include an update unit that may obtain data (e.g., data related to CSI feedback between the terminal and the base station) updated by a learning procedure between the terminal and the base station, and reconfigure values of parameters (e.g., a neural network structure, information for each node layer, and weight value information between nodes) configuring a neural network, based on the data. The AI-based CSI feedback controller and the update unit may be instructions/codes that are at least temporarily resident in the controller 330 as instruction sets or codes stored in the storage unit 320, or storage spaces for storing instructions/codes, or may be a part of circuitry configuring the controller 330. The controller 330 may control the terminals 120 and 130 to perform operations according to various embodiments.

The configuration of the terminals 120 and 130 shown in FIG. 3 is only an example of the terminal, and the terminal is not limited to the configuration shown in FIG. 3. That is, some configurations may be added, deleted, or changed.

For convenience of description, the disclosure will be described with reference to an AI model included in the terminals 120 and 130. That is, an AI model including a specific neural network structure and trained by a specific algorithm may be included in the terminals 120 and 130. However, the disclosure is not limited thereto, and may also be applied to an AI model included in the base station 110.

A technology related to AI-based CSI feedback may include performing training and configuration based on a specific algorithm to apply CSI feedback to a specific AI model, collecting learning data required in the process of training the specific AI model, and verifying performance of the specific trained AI model. In relation to the verifying of the performance of the specific trained AI model, the disclosure may further include an operation for predicting a channel based on an AI model and reporting channel prediction capability information by the terminal, so as to perform CSI feedback through an optimal AI model.

In describing an AI model-based CSI reporting method of the disclosure, for convenience, an AI model is described using an autoencoder (AE) as an example. However, the disclosure is not limited thereto, and may be applied to all AI models capable of CSI compression in performing a CSI report. The autoencoder is a structure in which input and output are the same, and may refer to an AI model including a bottleneck structure. The autoencoder may compress CSI measured by the terminal into a low-dimensional vector form. In other words, the terminal may generate compressed CSI from the measured full CSI through an encoder of the autoencoder, and transmit the compressed CSI to the base station. Accordingly, the base station may receive explicit CSI feedback rather than implicit CSI feedback. The autoencoder may have advantages in relation to a reporting manner through a CSI compression manner. For example, since the autoencoder is aware of a ground-truth value of the source of data even when inferring the performance of the AI model, the autoencoder may accurately evaluate the AI model. That is, since an input value of the autoencoder is known, the performance of the autoencoder may be measured by comparing the input value and an output value of the autoencoder. When the autoencoder is aware of the ground-truth value of the source of the data, a value to be output based on a value input to the autoencoder may be accurately predicted. In addition, since the autoencoder has high data dependency, the autoencoder may also be used for anomaly detection for detecting unlearned data.

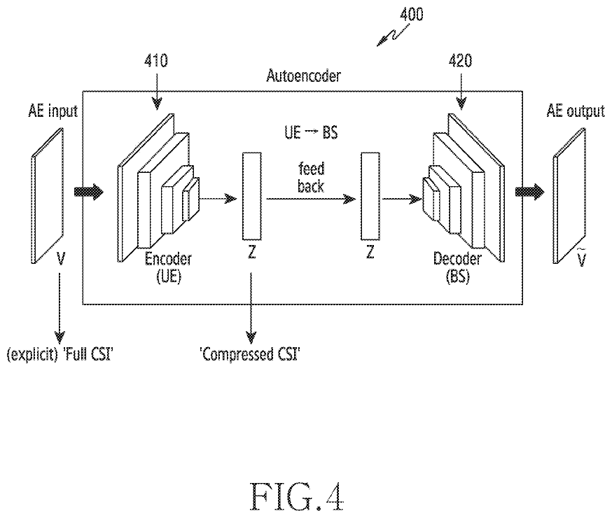

FIG. 4 illustrates a process of reporting CSI by using an AI model in a wireless communication system according to an embodiment. In FIG. 4, an autoencoder is described as an example as an AI model for reporting CSI (or for CSI feedback), but the disclosure is not limited thereto. It is assumed that the autoencoder for reporting CSI is an AI model which has been trained to report CSI based on a specific learning algorithm.

Referring to FIG. 4, an autoencoder 400 may be an AI model trained for a CSI report or feedback between a terminal and a base station. The terminal may generate CSI by pre-processing information on a channel estimated based on a result of measuring a signal received from the base station. For example, the pre-processing may include eigen value decomposition (EVD) or singular value decomposition (SVD). The generated CSI may refer to full CSI. The full CSI may be input to an encoder 410 of the terminal (or UE), which is an input of the autoencoder 400, and accordingly, compressed CSI may be generated. The terminal may transmit the compressed CSI to the base station, and the base station may restore the compressed CSI through a decoder 420. In this case, the decoder 420 of the base station may be an output of the autoencoder 400. The autoencoder 400 may learn CSI compression which may be used for CSI feedback between the terminal and the base station. The autoencoder 400 may perform explicit CSI feedback rather than implicit CSI feedback through feedback according to the learned CSI compression manner. The CSI compression manner may require stable performance and high accuracy of the autoencoder 400. Therefore, a procedure in which the terminal manages the autoencoder 400 by continuously and periodically monitoring the performance of the autoencoder 400 and reporting an evaluation result to the base station is required. Based on the foregoing, an operation for more efficiently performing a CSI report based on an AI model is described. The CSI disclosed for this purpose may refer to at least one of full CSI or compressed CSI.

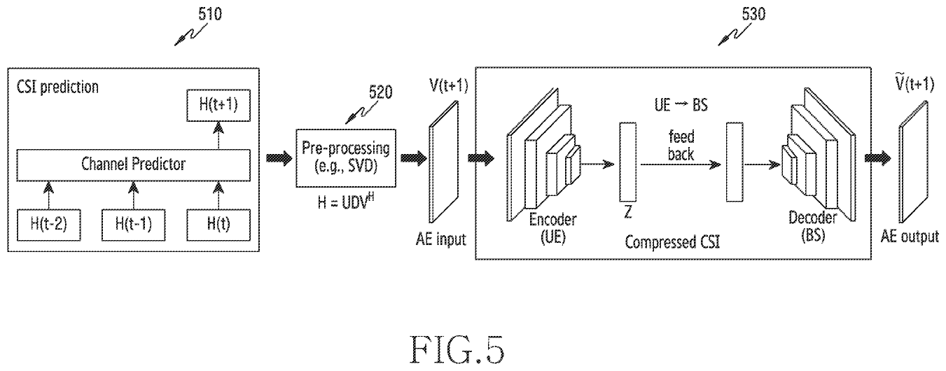

FIG. 5 illustrates a process of performing channel prediction and CSI compression using an AI model in a wireless communication system according to an embodiment. Specifically, FIG. 5 illustrates an operation of predicting a channel by using an AI model of a terminal and an operation of compressing and reporting CSI based on channel prediction.

Referring to FIG. 5, in step 510, an AI model (e.g., a channel predictor) for predicting a channel, the AI model being included in a terminal, may predict a future channel (e.g., channel matrix H(t+1), based on a previous channel measurement result (e.g., channel matrix H(t−2), H(t−1), H(t)) in the process of measuring successive channels. The AI model for predicting a channel may include a recurrent neural network (RNN) in which information obtained in a previous operation may be maintained through repetitive algorithm execution. In particular, the AI model included in the terminal may include long short term memory (LSTM)-based channel prediction having capability to perform learning requiring a longer dependency period, which is one of the types of RNN. Since LSTM may be a very useful AI model to process continuous data such as channels measured by the terminal, the terminal may use an LSTM model to predict a future channel, based on measurement results of previous channels. However, the AI model used by the terminal for channel prediction is not limited to an LSTM, and may include various AI models which perform functions similar or equivalent thereto.

The AI model included in the terminal may predict a future channel, based on at least one parameter for channel prediction. The parameter for channel prediction may include a prediction interval, the number of predicted time-steps, etc., but is not limited thereto, and may include various parameters required by the AI model for performing channel prediction.

The prediction interval may include time resolution (e.g., time difference) between neighboring input values input for channel prediction, and may affect the accuracy (e.g., prediction performance) of channels which are predicted. The prediction interval may include various units (time unit(μsec, msec), subframe, slot, or the like) including time. For example, the prediction interval may include a time interval between previous channels for channel prediction and a time interval between channels which are predicted.

The number of predicted time-steps may include the number of channels which can be predicted by the AI model. As the number of channels predicted by the AI model increases, the number of CSI-RSs that the terminal is required to receive from the base station for a CSI report may decrease. Therefore, to effectively reduce overhead of a CSI-RS, a larger number of predicted time-steps may be required. A case in which the covariance of a previous channel measured by the terminal and a predicted channel is small indicates that channel variation between the two channels is small, and since the performance of channel prediction can be guaranteed, the terminal may identify a larger number of predicted time-steps.

In step 520 of FIG. 5, the terminal may perform pre-processing on a channel (e.g., channel matrix H(t+1)) predicted based on the AI model to obtain a vector value (e.g., V(t+1)) for CSI compression. For example, the pre-processing may include EVD or SVD, and V, which is a vector value for CSI compression, may be generated based on Equation (1) as follows.

H=UDV^{H} (1)

Alternatively, V, which is a vector value for CSI compression, may be generated through EVD based on Equation (2) as follows.

V(t+1)=H^{H}(t+1)H(t+1) (2)

In step 530, the terminal may perform CSI compression and report, based on the vector value V. The terminal may compress the vector value V by using an encoder of an AE. The terminal may report z, which is a value of the compressed CSI, to the base station, and the base station may use a decoder of the AE to obtain V corresponding to the vector value V, and identify the CSI report of the terminal, based on the obtained V.

The above-described processes are only examples, but the disclosure is not limited thereto, and the terminal may include at least one of an AI model which performs channel prediction or an AI model which performs CSI compression, and may include performing a CSI report except for all or any one of the above-described operations. In particular, the terminal may receive, from the base station, configuration information including a parameter for performing AI-based CSI feedback (e.g., including AI-based channel prediction or CSI compression). Prior to this, a transmission/reception operation of information relating to whether the terminal supports AI-based CSI feedback or capability information including the performance of an AI model may be performed. For example, the terminal may transmit, to the base station, whether a CSI feedback mode with respect to at least one of AI-disabled feedback, AI-enabled prediction-based feedback, AI-enabled compression-based feedback, or AI-enabled prediction and compression-based feedback, which may also be considered as a default value, is supported, and the detailed description relating thereto will be described below.

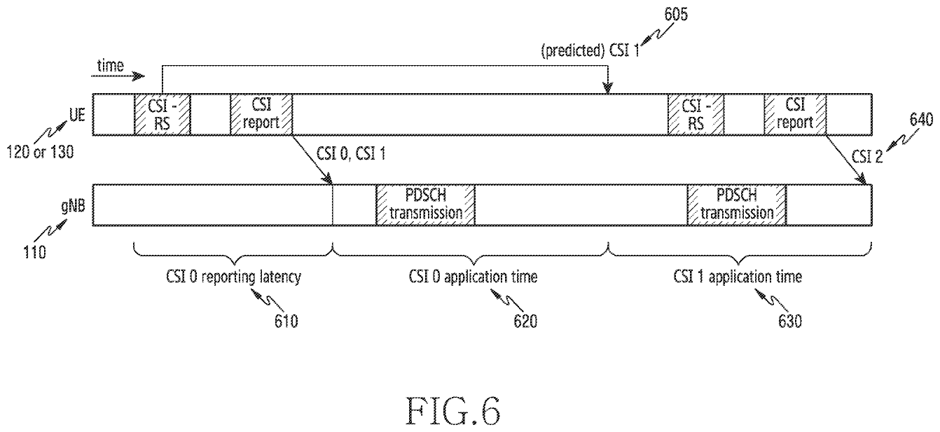

FIG. 6 illustrates a timeline in which CSI feedback is performed according to channel prediction using an AI model according to an embodiment. Specifically, FIG. 6 illustrates a CSI-RS and a CSI report performed with reference to a time axis when channel prediction is performed based on an AI model.

A terminal may measure a channel by receiving at least one CSI-RS. An operation of receiving and measuring past CSI-RS s by the terminal may include a training operation for AI model-based channel prediction. An AI model, which has measured past CSI-RSs and performed training of a channel prediction algorithm, based on the measured past CSI-RSs, may predict a channel at a time point after one or more time-steps, based on a CSI-RS received at a specific time point. The terminal may measure CSI, based on one or more predicted channels. The terminal may transmit one CSI report including CSI measured based on the received CSI-RS and CSI for predicted channels to the base station.

In FIG. 6, the terminal may receive a CSI-RS. The CSI-RS received by the terminal may be a signal for CSI 0. In step 605, the terminal may generate CSI 1 predicted based on the AI model as well as CSI 0 measured based on the received CSI-RS. The CSI 1 predicted by the terminal may be related to a channel prior to a time point of receiving the second CSI-RS. In step 610, the terminal may transmit one CSI report including the CSI 0 and CSI 1 to the base station, which may receive a CSI report including the CSI 0 and CSI 1 after a delay (latency) time for reporting the CSI 0. In step 620, the base station may schedule or transmit a downlink signal (e.g., a data signal including a physical downlink shared channel (PDSCH)), based on the received CSI report, i.e., may transmit a downlink signal based on the CSI 0 at a CSI 0 application time. In step 630, the base station may transmit a downlink signal based on the CSI 1 at a CSI 1 application time. In step 640, the terminal may receive the second CSI-RS only at the CSI 1 application time, and report CSI 2 measured based on the second CSI-RS to the base station. FIG. 6 illustrates a structure of transmitting CSI 2 based on the second CSI-RS, but the disclosure is not limited thereto, and the terminal may perform AI-based channel prediction on the second CSI-RS and transmit a CSI report on one or more predicted channels to the base station.

In FIG. 6, even when there is only one CSI-RS, the terminal may measure and report CSI for a plurality of channels by performing AI-based channel prediction. For example, as the terminal performs AI-based channel prediction, a CSI report delay of the CSI 1 may not occur, and waste of transmission and reception of a CSI-RS is reduced, thereby preventing the occurrence of CSI-RS overhead. In addition, a CSI report and CSI application time for each channel may also decrease according to the number of prediction channels (the number of time-steps) based on the AI model.

Herein, steps related to predicting a channel based on an AI model included in the terminal and performing CSI feedback are described, but the disclosure is not limited thereto, and a channel prediction operation based on an AI model included in the base station may be performed. Even when the base station includes an AI model for channel prediction, a similar operation to the case where the terminal includes the AI model may be performed. The terminal may measure a channel, based on the CSI-RS received from the base station. The terminal may determine a rank indicator (RI), a PMI, or a channel quality indicator (CQI) related to the measured channel, and transmit the same to the base station. The base station may predict CSI (e.g., CSI 1) at a time point after the transmitted CSI-RS, based on a received result value (e.g., CSI 0 report) of the channel measurement and an algorithm of the AI model. However, when the base station predicts a channel, unlike the AI model of the terminal which predicts a channel based on a raw channel measurement value, the channel prediction is performed based on RI/PMI/CQI, which is a discrete value, and thus it may be difficult to accurately reflect channel variation. For example, when channel variation is large, predicted RI/PMI/CQI may be measured differently according to the channel variation, and thus the accuracy of performing channel prediction may be somewhat lower than that of the AI model of the terminal.

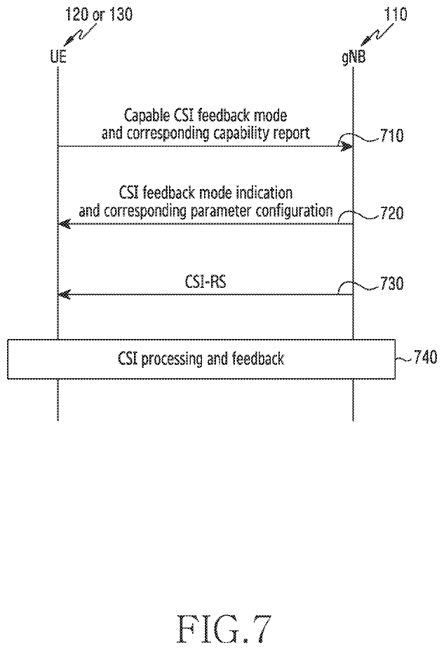

FIG. 7 illustrates a signal flow for channel prediction and CSI compression using an AI model according to an embodiment. Specifically, FIG. 7 illustrates a signal flow between a terminal and a base station in a communication environment in which CSI feedback is performed through AI model-based channel prediction or CSI compression. To perform channel prediction or CSI compression based on an AI model included in the terminal, the terminal and the base station are required to transmit or receive information on a CSI feedback mode or configuration information related to the determined CSI feedback mode.

In step 710, the terminal may transmit, to the base station, a CSI feedback mode supported by the terminal and capability information corresponding to the CSI feedback mode. The terminal may determine the CSI feedback mode supported by the terminal, based on the AI model included in the terminal. The CSI feedback mode supported by the terminal may include at least one of AI-disabled feedback, AI-enabled prediction-based feedback, AI-enabled compression-based feedback, or AI-enabled prediction and compression-based feedback. The terminal may determine the capability information corresponding to the CSI feedback mode, based on the supported CSI feedback mode. For example, the capability information corresponding to the AI-enabled prediction-based feedback may include information on a channel used to train channel prediction, information on an inference channel, inferred prediction interval information, AI performance information corresponding to a predicted channel, information on a compression ratio, AI performance information according to a compression ratio, and the like. The capability information transmitted by the terminal to the base station may refer to both the CSI feedback mode supported by the terminal and the capability information corresponding to the CSI feedback mode.

In step 720, the base station may transmit a CSI feedback mode indicator and parameter configuration information corresponding to the CSI feedback mode to the terminal. The base station may determine a CSI feedback mode to be indicated to the terminal, based on a CSI feedback mode available to the base station and the terminal. Alternatively, the base station may determine a CSI feedback mode to be indicated to the terminal in consideration of a system environment. The base station may determine the parameter configuration information corresponding to the CSI feedback mode. When the terminal performs AI-based channel prediction, the base station may determine configuration information including parameters relating to a prediction interval, a time-step for prediction, and the like. When the terminal performs AI-based CSI compression, the base station may determine configuration information including parameters relating to a CSI report mode, a compression mode (e.g., the number of feedback bits), and the like. The base station may transmit configuration information determined based on capability information of the terminal to the terminal.

In step 730, the base station may transmit a CSI-RS to the terminal. In step 740, the terminal may perform CSI processing, based on the received CSI-RS, and report CSI feedback to the base station by performing AI-based channel prediction or CSI compression, based on the CSI-RS received from the base station. In this case, a general procedure relating to CSI feedback defined in 3GPP may be applied to operations other than AI-based prediction and compression.

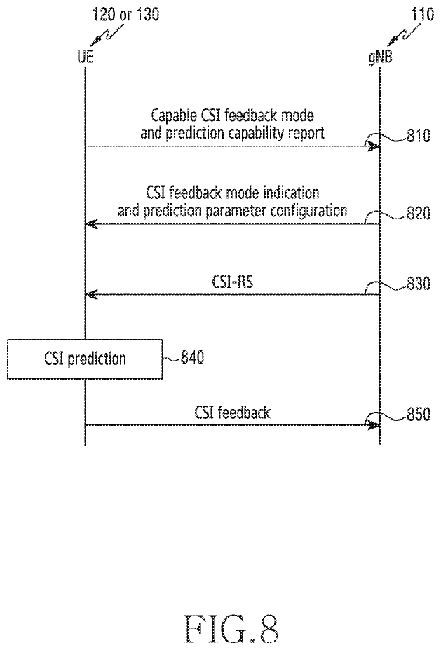

FIG. 8 illustrates a signal flow for channel prediction using an AI model according to an embodiment. Specifically, FIG. 8 illustrates a signal flow between a terminal and a base station for performing AI-based channel prediction by the terminal.

In step 810, the terminal may transmit a CSI feedback mode supported by the terminal and prediction capability information to the base station.

The terminal may determine the CSI feedback mode supported by the terminal, based on an AI model included in the terminal. The CSI feedback mode supported by the terminal may include at least one of AI-disabled feedback, AI-enabled prediction-based feedback, AI-enabled compression-based feedback, or AI-enabled prediction and compression-based feedback. The terminal may determine the CSI feedback mode, based on terminal processing capability and a cost value of the AI model. The terminal may transmit the CSI feedback mode determined based on a radio resource control (RRC) parameter or 2-bit signaling of uplink control information (UCI) to the base station.

The terminal may transmit, to the base station, index values corresponding to a plurality of feedback modes supported by the terminal. For example, indexes corresponding to the AI-disabled feedback, AI-enabled prediction-based feedback, AI-enabled compression-based feedback, and AI-enabled prediction and compression-based feedback may be 1 to 4, respectively. When the terminal supports AI-based prediction feedback, the terminal may determine and report an index of {1, 2}. When the terminal supports AI-based compression feedback, the terminal may determine and report an index of {1, 3}. Alternatively, when the terminal supports AI-based prediction and compression, the terminal may determine and report an index of {1, 2, 3, 4}. Index 1 corresponding to the AI-disabled feedback may refer to a default value.

The terminal may determine a highest feedback mode among indexes corresponding to the feedback modes supported by the terminal and transmit the highest feedback mode to the base station. For example, the indexes corresponding to the AI-disabled feedback, AI-enabled prediction-based feedback, AI-enabled compression-based feedback, and AI-enabled prediction and compression-based feedback may be 1 to 4, respectively. When the terminal supports AI-based prediction feedback, the terminal may determine and report an index of {2}. When the terminal supports AI-based compression feedback, the terminal may determine and report an index of {3}. Alternatively, when the terminal supports AI-based prediction and compression, the terminal may determine and report an index of {4}. Index 1 corresponding to the AI-disabled feedback may refer to a default value.

The terminal may determine capability information relating to prediction corresponding to a CSI feedback mode supported by the terminal. Hereinafter, the capability information may refer to information on prediction capability corresponding to the CSI feedback mode, but is not limited thereto, and the capability information transmitted by the terminal to the base station may also include information on the CSI feedback mode.

The capability information transmitted by the terminal may include information on a trained prediction interval used for learning by an AI model for channel prediction. For example, the trained prediction interval may include a time difference between past channels (e.g., H(t−2), H(t−1), H(t)) learned by the AI model for channel prediction. As an example, when the information on the trained prediction interval is {5, 40}, this indicates that the AI model of the terminal is trained with reference to long prediction interval 40 suitable for a low-speed scenario, and in relation to a short prediction interval suitable for a high-speed scenario, the AI model is trained with reference to 5. The prediction interval may be defined based on a time unit (time unit (μsec, msec), subframe, slot, or the like).

The capability information transmitted by the terminal may include information on AI-native performance corresponding to each prediction time-step. For example, the information on AI performance may include performance-related performance, and the performance-related performance may include mean squared error, cosine similarity, and the like. The information on AI performance may include complexity-related performance, and the complexity-related performance may include the number of required floating point operations per second (FLOPs) and inference latency. The information on AI performance may be categorized using generalized cosine similarity (GCS). The terminal may determine a GCS performance value of a predicted channel, based on

$$GCS ( {v}_{n} , {\hat{v}}_{n} ) = \frac{1}{N} {\sum }_{n} \frac{\vert {\hat{v}}_{n}^{H} {v}_{n} \vert}{{‖ {\hat{v}}_{n} ‖}_{2} {‖ {v}_{n} ‖}_{2}} .$$

The terminal may determine regression performance, based on a category of the determined GCS performance value for each time-step. For example, when AI performance categories 1 to 5 correspond to GCS performance values of 0.80, 0.85, 0.90, 0.95, and 1.00, respectively, the terminal may determine channel prediction relating to the first time-step as category 4 (that is, a GCS performance value of 0.95), channel prediction relating to the 25 second time-step as category 3 (that is, a GCS performance value of 0.90), and channel prediction relating to the third time-step as category 1 (that is, a GCS performance value of 0.80). In this case, it may mean that AI performance relating to channel prediction decreases as the time-step increases.

The capability information transmitted by the terminal may include information on generalization performance. The generalization performance information may include information applicable to various parameters, scenarios, or configurations together with or in addition to the above-described information. In particular, performance degradation may be reduced when the AI model generalizes and processes a data set used for training. The information on the generalization performance may include information on a prediction interval during training and information on AI performance for each prediction interval during inference. For example, when the AI model is trained at prediction intervals of 20 ms, during inference at prediction intervals of 20 ms, GCS performance may be category 4 (that is, a GCS performance value of 0.95), and during inference at prediction intervals of 10 ms, the GCS performance may be determined as a category 3 (that is, a GCS performance value of 0.90), and the terminal may transmit capability information including the above-described information to the base station.

The terminal may transmit the determined capability information to the base station on a one-time basis. For example, regardless of prediction of an actual channel, the terminal may identify the performance of the AI model included in the terminal, and the performance may be previously input to the terminal. Therefore, the terminal may transmit the capability information determined based on the performance of the AI model included in the terminal to the base station, regardless of any trigger. The terminal may receive an actual CSI-RS and identify prediction performance, based on a channel estimated based on the CSI-RS. In this case, the terminal may transmit the capability information according to a request of the base station, or may transmit the capability information, based on a periodic report, according to the configuration of the base station. The terminal may identify information on the AI model (the number of layers for AI learning, etc.) according to a memory in use in real-time and computational complexity. In this case, when the memory is insufficient, the terminal may transmit capability information relating to a simplified AI model, or may periodically transmit capability information according to availability of hardware or software of the terminal.

In step 820, the base station may transmit a CSI feedback mode indicator and configuration information relating to AI-based channel prediction to the terminal.

Specifically, the base station may determine a CSI feedback mode, based on information on a CSI feedback mode supportable by the terminal, the information being received from the terminal. The base station may determine a highest feedback mode among feedback modes which are usable by both the terminal and the base station, and configure the highest feedback mode to the terminal. For example, the base station may determine the CSI feedback mode, based on a CSI feedback mode index received from the terminal, and may transmit an indicator indicating the determined CSI feedback mode to the terminal. The base station may determine the CSI feedback mode by further considering a system environment. For example, when a terminal moves at high speed, frequent CSI-RS transmission may be required due to a short channel coherence time. Accordingly, to reduce CSI-RS overhead, the base station may determine a feedback mode including AI-based prediction. Alternatively, when the surrounding channel environment dynamically changes, to reduce the delay of CSI application, the base station may determine the feedback mode including AI-based prediction. Alternatively, when the number of terminals RRC-connected to the base station increases, due to a limited feedback resource (e.g., a physical uplink control channel (PUCCH)), the base station may determine a feedback mode including AI-based compression to reduce feedback overhead. As described above, the base station may determine the CSI feedback mode, based on at least one of the CSI feedback mode supported by the terminal or the system environment, and configure the determined CSI feedback mode to the terminal.

The base station may determine configuration information for AI-based channel prediction, based on the capability information received from the terminal.

The base station may determine the number of time-steps for performing prediction by the AI model of the terminal A time-step may refer to a channel through which the AI model is to perform prediction. For example, the base station may determine a prediction parameter through a measured signal-to-interference-plus-noise ratio (SINR) and measured spectral efficiency, based on GCS performance. The base station may estimate an SINR, based on

$$SINR = \frac{{( {v}_{1}^{H} {\tilde{v}}_{1} )}^{2}}{{σ}_{n}^{2} + {( {v}_{1}^{H} {\tilde{v}}_{2} )}^{2}}$$

and a reported GCS performance value for each time-step included in the capability information. In this case, the base station may configure, to the terminal, a prediction parameter (e.g., prediction time-step=1) with respect to a time-step corresponding to an SINR which satisfies a specific threshold value or higher.

Further in step 820, the base station may determine a prediction interval for performing prediction by the AI model of the terminal. The prediction interval may refer to an interval between channels through which the AI model is to perform measurement or prediction. For example, the base station may determine a prediction parameter, based on GCS performance and a feedback period. When a channel coherence time (T_{c}) is given as 5.3 ms

$${T}_{c} \approx \sqrt{\frac{9}{16 π}} \frac{c}{{vf}_{c}} = 5.3 ms ,$$

where v=25 km/h and f_{c}=3.5 GHz), the base station may require a feedback period of 5 ms for CSI feedback within 5.3 ms. Therefore, when the prediction time-step determined based on the GCS performance included in the capability information is 1, the base station may configure, to the terminal, information indicating that a prediction interval is 5 ms and a prediction time-step is 1. In this case, an actual CSI-RS transmission period is 10 ms, whereas an interval between CSIs in which the terminal performs prediction and report is 5 ms, and thus overhead due to a CSI-RS can be reduced by a half.

In step 830, the base station may transmit a CSI-RS to the terminal.

In step 840, the terminal may perform CSI prediction, based on the CSI feedback mode indicator received from the base station and the configuration information relating to AI-based channel prediction. For example, in addition to channel estimation based on the CSI-RS received from the base station, the terminal may perform prediction relating to as many channels following thereafter as time-steps.

In step 850, the terminal may transmit a CSI report (e.g. CSI feedback) including CSI relating to a measured channel and a predicted channel to the base station.

The above-described information, parameter, or specific index and value is only an example, but the disclosure is not limited thereto, and the above-described embodiments may operate independently or in combination, or may further include operations or information similar or substantially equivalent thereto.

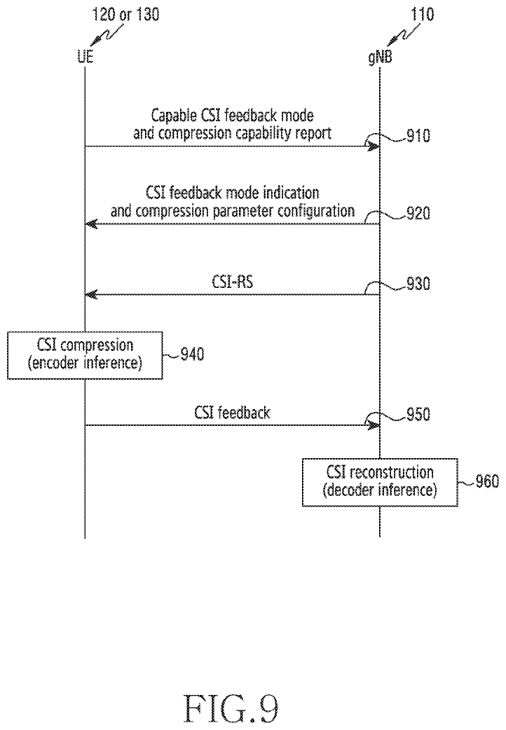

FIG. 9 illustrates a signal flow for CSI compression using an AI model according to an embodiment. Specifically, FIG. 9 illustrates a signal flow between a terminal and a base station for performing AI-based channel compression by the terminal.

In step 910, the terminal may transmit a CSI feedback mode supported by the terminal and AI-based CSI compression capability information to the base station.

The terminal may determine the CSI feedback mode supported by the terminal, based on an AI model included in the terminal. The CSI feedback mode supported by the terminal may include at least one of AI-disabled feedback, AI-enabled prediction-based feedback, AI-enabled compression-based feedback, or AI-enabled prediction and compression-based feedback. The terminal may determine the CSI feedback mode, based on terminal processing capability and a cost value of the AI model. The terminal may transmit the CSI feedback mode determined based on a radio resource control (RRC) parameter or 2-bit signaling of uplink control information (UCI) to the base station. The terminal may transmit, to the base station, index values corresponding to a plurality of feedback modes supported by the terminal. For example, indexes corresponding to the AI-disabled feedback, AI-enabled prediction-based feedback, AI-enabled compression-based feedback, and AI-enabled prediction and compression-based feedback may be 1 to 4, respectively. When the terminal supports AI-based prediction feedback, the terminal may determine and report an index of {1, 2}. When the terminal supports AI-based compression feedback, the terminal may determine and report an index of {1, 3}. Alternatively, when the terminal supports AI-based prediction and compression, the terminal may determine and report an index of {1, 2, 3, 4}. Index 1 corresponding to the AI-disabled feedback may refer to a default value.

The terminal may determine a highest feedback mode among indexes corresponding to the feedback modes supported by the terminal and transmit the highest feedback mode to the base station. For example, the indexes corresponding to the AI-disabled feedback, AI-enabled prediction-based feedback, AI-enabled compression-based feedback, and AI-enabled prediction and compression-based feedback may be 1 to 4, respectively. When the terminal supports AI-based prediction feedback, the terminal may determine and report an index of {2}. When the terminal supports AI-based compression feedback, the terminal may determine and report an index of {3}. Alternatively, when the terminal supports AI-based prediction and compression, the terminal may determine and report an index of {4}. Index 1 corresponding to the AI-disabled feedback may refer to a default value.

Further in step 910, the terminal may determine capability information relating to CSI compression corresponding to the CSI feedback mode supported by the terminal. Hereinafter, the capability information may refer to information on compression capability corresponding to the CSI feedback mode, but is not limited thereto, and the capability information transmitted by the terminal to the base station may also include information on the CSI feedback mode.

The capability information transmitted by the terminal may include a representative metric of CSI compression used for learning by the AI model for CSI compression. For example, the representative metric of CSI compression may include a generalized cosine similarity (GCS) value in the case of Tx eigenvector compression, a mean squared error (MSE) value in the case of raw channel compression, or a compression ratio (γ) representing the degree to which AI compresses an input value into a codeword. The compression ratio may include a compression ratio of a value (z, dim(z)=2NₜNₛ×γ) obtained by compression through an autoencoder based on a channel matrix (H, dim(H)=2×Nₜ×Nₛ). The AI of the terminal may identify a compression ratio corresponding to a GCS value which satisfies greater than or equal to a threshold value during a compression learning procedure. For example, the terminal may identify that respective compression ratios satisfying GCS of 0.95, 0.90, 0.85, and 0.80 or higher are ½, ¼, ⅛, and 1/16, and identify respective indexes 0 to 3 corresponding thereto. Alternatively, the terminal may identify GCS performance information according to a predefined compression ratio. For example, when AI performance categories corresponding to GCS performance values of 0.7, 0.8, and 0.9, respectively, are category 1, category 2, and category 3, the terminal may identify mapping information in which compression ratios of 1/32, ⅛, and ½ correspond to category 1 (that is, a GCS performance value of 0.7), category 2 (that is, a GCS performance value of 0.8), and category 3 (that is, a GCS performance value of 0.9), respectively. In this case, AI performance relating to channel compression decreases as the compression ratio increases. The capability information transmitted by the terminal is not limited to the above-described example, and may include information having a function similar to or substantially equivalent to performance information which may be identified by the terminal for AI-based CSI compression.

In step 920, the base station may transmit a CSI feedback mode indicator and configuration information relating to AI-based CSI compression to the terminal.

The base station may determine a CSI feedback mode, based on information on a CSI feedback mode supportable by the terminal, the information being received from the terminal. The base station may determine a highest feedback mode among feedback modes which are usable by both the terminal and the base station, and configure the highest feedback mode to the terminal. For example, the base station may determine the CSI feedback mode, based on a CSI feedback mode index received from the terminal, and may transmit an indicator indicating the determined CSI feedback mode to the terminal. The base station may determine the CSI feedback mode by further considering a system environment. For example, in the case of a terminal which moves at high speed, frequent CSI-RS transmission may be required due to a short channel coherence time, and accordingly, to reduce CSI-RS overhead, the base station may determine a feedback mode including AI-based prediction. Alternatively, when the surrounding channel environment dynamically changes, to reduce the delay of CSI application, the base station may determine the feedback mode including AI-based prediction. Alternatively, when the number of terminals RRC-connected to the base station increases, due to a limited feedback resource (e.g., a physical uplink control channel (PUCCH)), the base station may determine a feedback mode including AI-based compression to reduce feedback overhead. As described above, the base station may determine the CSI feedback mode, based on at least one of the CSI feedback mode supported by the terminal or the system environment, and configure the determined CSI feedback mode to the terminal.

The base station may determine configuration information for AI-based CSI compression, based on the capability information received from the terminal.

The base station may determine a report mode according to a wideband or subband report, and configure the determined report mode to the terminal. For example, the base station may configure the report mode to be 1 to configure only the wideband report, or may configure the report mode to be 2 to configure the wideband and subband report. When frequency selectivity of a channel is low (e.g. bad), a change rate of the channel may be low, and thus the base station may configure the report mode to be 1 for the wideband report. Alternatively, when the frequency selectivity of the channel is high (e.g. good), the change rate of the channel may be high, and thus the base station may configure the report mode to be 2 for the subband report.

The base station may determine a compression mode according to the number of feedback bits, and configure the determined compression mode to the terminal. For example, the base station may configure one of compression modes 0 to 3 corresponding to compression ratios of ½, ¼, ⅛, and 1/16, respectively, to the terminal. The base station may determine a compression mode in consideration of a PUCCH resource based on the number of terminals RRC-connected to the base station. For example, when the number of connected terminals increases compared to a PUCCH resource which is allocatable by the base station, it is necessary to reduce overhead of CSI feedback, and thus the base station may identify a compression ratio greater than or equal to a specific threshold value among GCS values included in the capability information, and determine a compression mode having a high compression ratio. The base station may determine a compression mode, based on the quality of a channel restored through an autoencoder. For example, when high restoration quality is required, the base station may determine a compression mode having a small compression ratio.

The base station may transmit the identified configuration information for AI-based CSI compression to the terminal. A parameter or specific information of the configuration information identified by the base station is not limited to the above example, and may include a parameter or information similar or substantially equivalent thereto.

In step 930, the base station may transmit a CSI-RS to the terminal.

In step 940, the terminal may perform CSI compression, based on the CSI feedback mode indicator received from the base station and the configuration information relating to AI-based CSI compression. For example, an autoencoder included in the terminal may compress preprocessed CSI information, based on the configuration information received from the base station through an encoder.

In step 950, the terminal may transmit a CSI report including compressed CSI to the base station.

In step 960, the base station may restore the CSI report through a decoder of the autoencoder.

The above-described information, parameter, or specific index and value is only an example, but the disclosure is not limited thereto, and the above-described embodiments may operate independently or in combination, or may further include operations or information similar or substantially equivalent thereto.

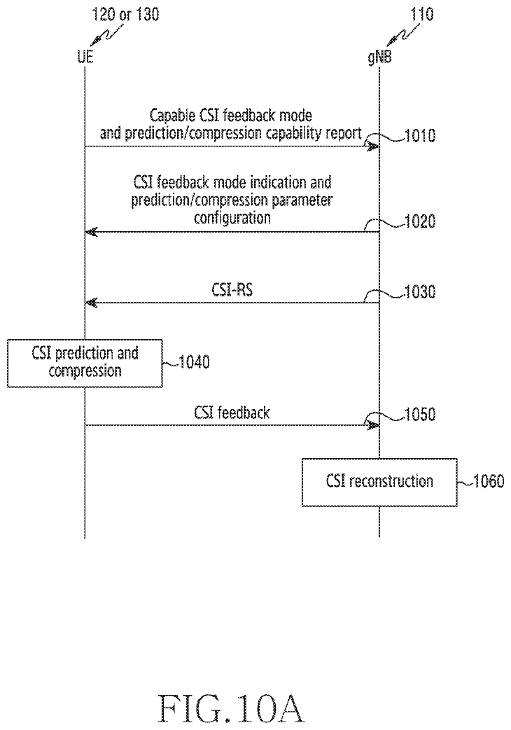

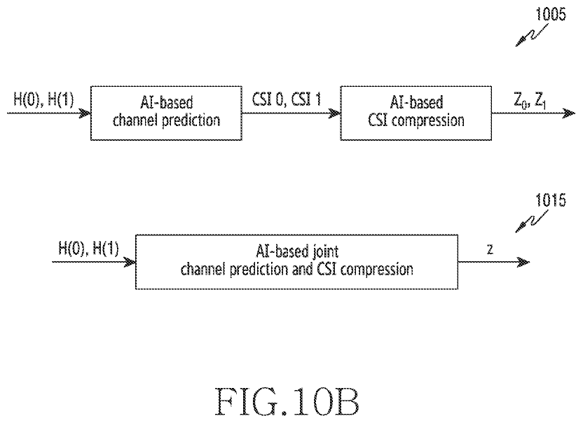

FIG. 10A illustrates a signal flow for combined execution of CSI compression and channel prediction using an AI model according to an embodiment. Specifically, FIG. 10A illustrates a signal flow between a terminal and a base station for independent or combined execution of AI-based channel prediction and CSI compression.

In step 1010, the terminal may transmit a CSI feedback mode supported by the terminal and capability information relating to AI-based channel prediction and CSI compression to the base station. When the terminal performs CSI compression relating to a predicted channel, based on AI and a current channel measured by the terminal, the capability information transmitted by the terminal may also include information on whether CSI compression for each channel may be independently performed or whether CSI compression may be performed by combining respective channels. For example, when the terminal includes an AI model which independently performs CSI compression for each CSI, the capability information transmitted by the terminal may include information (e.g., report 00) indicating an independent CSI compression report. Alternatively, when the terminal includes an AI model which performs CSI compression by combining CSIs of the current channel and predicted channels, the capability information transmitted by the terminal may include information (e.g., report 01) indicating a combined CSI compression report. Alternatively, when the terminal includes an AI model capable of performing both independent compression and combination compression, the capability information transmitted by the terminal may include information (e.g., report 10) indicating that all of the above reports may be performed.

Further in step 1010, the terminal may perform an operation including a part of step 810 of FIG. 8 or step 910 of FIG. 9 or a combination thereof for AI-based channel prediction and CSI compression.

In step 1020, the base station may determine a CSI feedback mode indicator and configuration information for AI-based channel prediction and CSI compression, and configure the same to the terminal.

In step 1030, the base station may transmit a CSI-RS to the terminal.

In step 1040, the terminal may perform CSI prediction and CSI compression, based on the CSI feedback mode indicator received from the base station and the configuration information relating to AI-based channel prediction and CSI compression. For example, in addition to channel estimation based on the CSI-RS received from the base station, the terminal may perform prediction relating to as many channels following thereafter as time-steps. For example, an autoencoder included in the terminal may compress preprocessed CSI information, based on the configuration information received from the base station through an encoder.

In step 1050, the terminal may transmit a CSI report including compressed CSI to the base station.

In step 1060, the base station may restore the CSI report through a decoder of the autoencoder.

The above-described information, parameter, or specific index and value is only an example, but the disclosure is not limited thereto, and the above-described embodiments may operate independently or in combination, or may further include operations or information similar or substantially equivalent thereto.

FIG. 10B illustrates an independent or combined execution of CSI compression and channel prediction using an AI model according to an embodiment. Specifically, FIG. 10B illustrates a result of independent or combined execution of AI-based channel prediction and CSI compression according to the steps disclosed in FIG. 10A.

In step 1005, the terminal may independently perform CSI compression on each of measured CSIs. For example, the terminal may perform AI-based channel prediction, based on at least one channel, and accordingly, identify CSI for a current channel and CSI for a predicted channel (e.g., CSI 0 and CSI 1). The terminal may perform AI-based CSI compression on each of the identified CSIs, and may obtain compressed CSI values Z0 and Z1.

In step 1015, the terminal may perform CSI compression by combining the measured CSIs. For example, the terminal may perform AI-based channel prediction, based on at least one channel, and accordingly, perform AI-based CSI compression by combining the CSI for the current channel and the CSI for the predicted channel, and may obtain a compressed CSI value Z.

When the terminal performs CSI compression by combining the measured CSIs, an AI model included in the terminal may perform end-to-end machine learning in which a prediction task and a compression task are integrated, and thus it may be easier to optimize weight values performing a neural network operation. However, a task to be learned by the AI model may be more complex compared to the case of independently performing CSI compression, and a large number of model parameters may be required, and thus a memory for storing the AI model and computational complexity may increase. Therefore, the terminal or network may adaptively determine at least one of independent compression or combination compression in light of each situation.

A CSI feedback mode or configuration information may be changed while the terminal and the base station perform operations according to the AI-based CSI feedback manner shown in FIGS. 1 to 10B.

The CSI feedback mode or the configuration information may be triggered by the terminal and changed. The terminal may report a preferred CSI feedback mode to be changed or a parameter corresponding thereto to the base station in a situation of performing an AI-based CSI feedback operation or a situation of performing a CSI feedback operation independently of AI. For example, when the terminal identifies a decrease in channel covariance or a decrease in channel coherence time, based on channel estimation, the terminal may identify that channel variation has decreased, and accordingly, may transmit an AI prediction-based feedback mode as a preferred CSI feedback mode. Therefore, the terminal can prevent performance degradation by performing channel prediction when a CSI-RS resource is fixed. For example, when the terminal identifies an increase in channel covariance or an increase in channel coherence time, based on channel estimation, the terminal may identify that channel variation has increased, and accordingly, may transmit an AI compression-based feedback mode as a preferred CSI feedback mode.

The terminal may report a preferred CSI feedback mode to be changed or a parameter corresponding thereto to the base station, when performing an AI-based CSI feedback operation or a situation of performing a CSI feedback operation independently of AI. For example, when the terminal identifies a decrease in channel covariance, based on channel estimation, the terminal may identify that channel variation has decreased, and accordingly, may transmit the operating parameter in which a prediction time-step has been increased as a preferred parameter to the base station. For example, when the terminal identifies an increase in channel covariance, based on channel estimation, the terminal may identify that channel variation has increased, and accordingly, may transmit the operating parameter in which a compression degree has been increased as a preferred parameter to the base station.

The disclosure is not limited to the above-described example, the terminal may adaptively identify a preferred CSI feedback mode or a parameter corresponding thereto, based on at least one of the above-described situations, and transmit the same to the base station, and these steps may be performed before or after any of those in FIGS. 7 to 10B.

The CSI feedback mode or the configuration information may be triggered by the base station and changed. The base station may configure a preferred CSI feedback mode to be changed or a parameter corresponding thereto to the terminal, in a situation of performing an AI-based CSI feedback operation or a situation of performing a CSI feedback operation independently of AI. For example, the base station may identify whether a decrease in overhead of a CSI-RS resource is required or a decrease in feedback overhead is required due to an increase in the number of connected terminals, and accordingly, configure at least one of an AI prediction-based feedback mode or an AI compression-based feedback mode to the terminal. During performance monitoring, the base station may identify performance degradation due to the use of a prediction channel or performance degradation due to the use of a compression mode, and accordingly, configure an AI-disabled feedback mode to the terminal.

The base station may configure a preferred CSI feedback mode to be changed or a parameter corresponding thereto to the terminal, in a situation of performing an AI-based CSI feedback operation or a situation of performing a CSI feedback operation independently of AI. For example, when the number of connected terminals increases or the number of antenna ports increases due to introduction of massive MIMO, the base station may identify whether a decrease in overhead of a CSI-RS resource is required or a decrease in feedback overhead is required, and accordingly, configure, to the terminal, a parameter in which a prediction time-step has been increased or a parameter in which a compression degree has been increased. For example, during performance monitoring, the base station may identify performance degradation due to the use of a prediction channel or performance degradation due to the use of a compression mode, and accordingly, configure, to the terminal, a parameter in which a prediction time-step has been decreased or a parameter in which a compression degree has been decreased.

The disclosure is not limited to the above-described example, the base station may adaptively identify a preferred CSI feedback mode or a parameter corresponding thereto, based on at least one of the above-described situations, and configure the same to the terminal, and these operations may be performed before or after any of the operations in FIGS. 7 to 10B

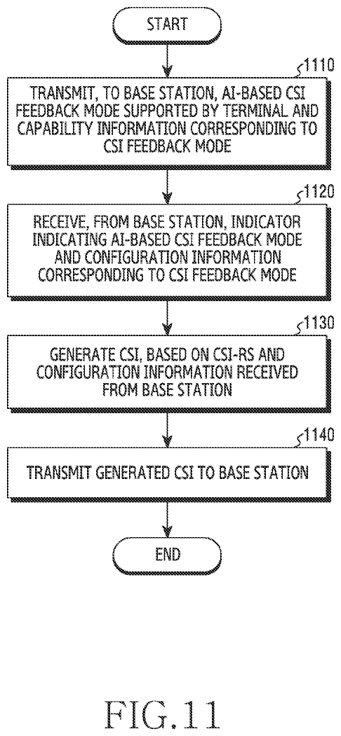

FIG. 11 illustrates a method of a UE for channel prediction and CSI compression using an AI model according to an embodiment. Specifically, FIG. 11 illustrates a method of a UE in a communication environment in which CSI feedback is performed through AI model-based channel prediction or CSI compression. A flow of terminal operations of FIG. 11 may include all, some, or a combination of some of the operations of the terminal disclosed in FIGS. 7 to 10B.

In step 1110, the terminal may transmit a CSI feedback mode supported by the terminal and capability information corresponding to the CSI feedback mode to a base station. The terminal may transmit the CSI feedback mode supported by the terminal and the capability information corresponding to the CSI feedback mode to the base station. The terminal may determine the CSI feedback mode supported by the terminal, based on an AI model included in the terminal. The CSI feedback mode supported by the terminal may include at least one of AI-disabled feedback, AI-enabled prediction-based feedback, AI-enabled compression-based feedback, or AI-enabled prediction and compression-based feedback. The terminal may determine the capability information corresponding to the CSI feedback mode, based on the supported CSI feedback mode. For example, the capability information corresponding to the AI-enabled prediction-based feedback may include information on a channel used to train channel prediction, information on an inference channel, inferred prediction interval information, AI performance information corresponding to a predicted channel, and the like. In addition, the capability information corresponding to the AI-enabled compression-based feedback may include information on a compression ratio, AI performance information according to a compression ratio, and the like. The capability information transmitted by the terminal to the base station may refer to both the CSI feedback mode supported by the terminal and the capability information corresponding to the CSI feedback mode.

In step 1120, the terminal may receive an indicator indicating an AI-based CSI feedback mode and configuration information corresponding to the CSI feedback mode from the base station. The terminal may receive a CSI feedback mode indicator and parameter configuration information corresponding to the CSI feedback mode from the base station. The base station may determine a CSI feedback mode to be indicated to the terminal, based on a CSI feedback mode available to the base station and the terminal. Alternatively, the base station may determine a CSI feedback mode to be indicated to the terminal in consideration of a system environment. The base station may determine the parameter configuration information corresponding to the CSI feedback mode. When the terminal performs AI-based channel prediction, the base station may determine configuration information including parameters relating to a prediction interval, a time-step for prediction, and the like. When the terminal performs AI-based CSI compression, the base station may determine configuration information including parameters relating to a CSI report mode, a compression mode (e.g., the number of feedback bits), and the like. The base station may transmit configuration information determined based on capability information of the terminal to the terminal.

In step 1130, the terminal may generate CSI, based on a CSI-RS and the configuration information received from the base station. In step 1140, the terminal may transmit the generated CSI to the base station. The base station may transmit a CSI-RS to the terminal, and the terminal may perform CSI processing, based on the received CSI-RS, and report CSI feedback to the base station. The terminal may report the CSI feedback by performing AI-based channel prediction or CSI compression, based on the CSI-RS received from the base station. In this case, a general procedure relating to CSI feedback defined in 3GPP may be applied to operations other than AI-based prediction and compression according to an embodiment.

Herein, names and contents of the above-described information or parameters are only examples, but the disclosure is not limited thereto, and information or parameters for performing functions similar or substantially identical thereto may be used. In addition, the respective operations may be performed independently or in combination, and are not limited to essential configurations for the embodiments of the disclosure.

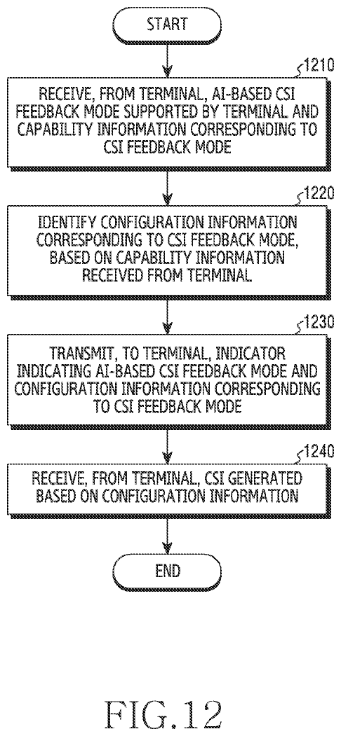

FIG. 12 illustrates a method of a base station for channel prediction and CSI compression using an AI model according to an embodiment. Specifically, FIG. 12 illustrates a method of a base station in a communication environment in which CSI feedback is performed through AI model-based channel prediction or CSI compression. of the operations of the base station disclosed in FIGS. 7 to 10B.

In step 1210, the base station may receive a CSI feedback mode supported by a terminal and capability information corresponding to the CSI feedback mode from the terminal. The base station may receive the CSI feedback mode supported by the terminal and the capability information corresponding to the CSI feedback mode from the terminal. The terminal may determine the CSI feedback mode supported by the terminal, based on an AI model included in the terminal. The CSI feedback mode supported by the terminal may include at least one of AI-disabled feedback, AI-enabled prediction-based feedback, AI-enabled compression-based feedback, or AI-enabled prediction and compression-based feedback. The terminal may determine the capability information corresponding to the CSI feedback mode, based on the supported CSI feedback mode. For example, the capability information corresponding to the AI-enabled prediction-based feedback may include information on a channel used to train channel prediction, information on an inference channel, inferred prediction interval information, AI performance information corresponding to a predicted channel, information on a compression ratio, AI performance information according to a compression ratio, and the like. The capability information received by the base station from the terminal may refer to both the CSI feedback mode supported by the terminal and the capability information corresponding to the CSI feedback mode.

In step 1220, the base station may identify configuration information corresponding to the CSI feedback mode, based on the capability information received from the terminal.

In step 1230, the base station may transmit an indicator indicating an AI-based CSI feedback mode and configuration information corresponding to the CSI feedback mode to the terminal. The base station may transmit a CSI feedback mode indicator and parameter configuration information corresponding to the CSI feedback mode to the terminal. The base station may determine a CSI feedback mode to be indicated to the terminal, based on a CSI feedback mode available to the base station and the terminal. Alternatively, the base station may determine a CSI feedback mode to be indicated to the terminal in consideration of a system environment. The base station may determine the parameter configuration information corresponding to the CSI feedback mode. When the terminal performs AI-based channel prediction, the base station may determine configuration information including parameters relating to a prediction interval, a time-step for prediction, and the like. When the terminal performs AI-based CSI compression, the base station may determine configuration information including parameters relating to a CSI report mode, a compression mode (e.g., the number of feedback bits), and the like. The base station may transmit configuration information determined based on capability information of the terminal to the terminal.

In step 1240, the base station may receive CSI generated based on the configuration information from the terminal. The base station may transmit a CSI-RS to the terminal, and the terminal may perform CSI processing, based on the received CSI-RS, and report CSI feedback to the base station. The terminal may report the CSI feedback by performing AI-based channel prediction or CSI compression, based on the CSI-RS received from the base station. In this case, a general procedure relating to CSI feedback defined in 3GPP may be applied to operations other than AI-based prediction and compression according to an embodiment.

The names and contents of the above-described information or parameters are only examples, but the disclosure is not limited thereto, and information or parameters for performing functions similar or substantially identical thereto may be used. In addition, the respective steps may be performed independently or in combination, and are not limited to essential configurations for the embodiments of the disclosure.

As described above, a method performed by a terminal in a wireless communication system may include transmitting, to a base station, an AI-based CSI feedback mode supported by an AI model of the terminal and capability information corresponding to the CSI feedback mode, wherein the AI-based CSI feedback mode supported by the AI model of the terminal includes at least one of an AI-based channel prediction mode or an AI-based CSI compression mode, receiving, from the base station, an indicator indicating a CSI feedback mode performed by the terminal and configuration information corresponding to the CSI feedback mode performed by the terminal, generating CSI, based on the received configuration information and a CSI-RS, and transmitting the generated CSI to the base station.

Herein, when the AI-based CSI feedback mode supported by the AI model of the terminal includes the AI-based channel prediction mode, the configuration information corresponding to the CSI feedback mode performed by the terminal may include information on a prediction interval and information on the number of prediction time-steps.

In addition, when the AI-based CSI feedback mode supported by the AI model of the terminal includes the AI-based CSI compression mode, the configuration information corresponding to the CSI feedback mode performed by the terminal may include information on a report mode indicating at least one of a wideband report or a subband report and information on a compression mode indicating a compression ratio.

The method may further include transmitting, to the base station, information indicating whether to independently compress channels for which the terminal has performed AI-based channel prediction, or compress the channels in combination.

The method may further include identifying whether to change the AI-based CSI feedback mode, based on a channel estimation result, and transmitting, to the base station, an AI-based CSI feedback mode preferred by the terminal or a parameter corresponding to the AI-based CSI feedback mode preferred by the terminal, based on a result of the identification.

As described above, a method performed by a base station in a wireless communication system may include receiving, from a terminal, an AI-based CSI feedback mode supported by an AI model of the terminal and capability information corresponding to the CSI feedback mode, wherein the AI-based CSI feedback mode supported by the AI model of the terminal includes at least one of an AI-based channel prediction mode or an AI-based CSI compression mode, identifying an indicator indicating a CSI feedback mode performed by the terminal and configuration information corresponding to the CSI feedback mode performed by the terminal, based on the received capability information, transmitting, to the terminal, the indicator indicating the CSI feedback mode performed by the terminal and the configuration information corresponding to the CSI feedback mode performed by the terminal, and receiving, from the terminal, CSI generated based on the transmitted configuration information and a CSI-RS.

Herein, when the AI-based CSI feedback mode supported by the AI model of the terminal includes the AI-based channel prediction mode, the configuration information corresponding to the CSI feedback mode performed by the terminal may include information on a prediction interval and information on the number of prediction time-steps.

In addition, when the AI-based CSI feedback mode supported by the AI model of the terminal includes the AI-based CSI compression mode, the configuration information corresponding to the CSI feedback mode performed by the terminal may include information on a report mode indicating at least one of a wideband report or a subband report and information on a compression mode indicating a compression ratio.

The method may further include receiving, from the terminal, information indicating whether to independently compress channels for which the terminal has performed AI-based channel prediction, or compress the channels in combination.

The method may further include identifying whether to change the AI-based CSI feedback mode, based on the number of terminals connected to the base station or performance of the AI model included in the terminal, and transmitting, to the terminal, an indicator indicating a CSI feedback mode to be changed and configuration information corresponding to the CSI feedback mode to be changed, based on a result of the identification.

As described above, a terminal in a wireless communication system may include at least one transceiver, and at least one processor functionally coupled to the at least one transceiver, wherein the at least one processor is configured to transmit, to a base station, an AI-based CSI feedback mode supported by an AI model of the terminal and capability information corresponding to the CSI feedback mode, wherein the AI-based CSI feedback mode supported by the AI model of the terminal includes at least one of an AI-based channel prediction mode or an AI-based CSI compression mode, receive, from the base station, an indicator indicating a CSI feedback mode performed by the terminal and configuration information corresponding to the CSI feedback mode performed by the terminal, generate CSI, based on the received configuration information and a CSI-RS, and transmit the generated CSI to the base station.

Herein, when the AI-based CSI feedback mode supported by the AI model of the terminal includes the AI-based channel prediction mode, the configuration information corresponding to the CSI feedback mode performed by the terminal may include information on a prediction interval and information on the number of prediction time-steps.

In addition, when the AI-based CSI feedback mode supported by the AI model of the terminal includes the AI-based CSI compression mode, the configuration information corresponding to the CSI feedback mode performed by the terminal may include information on a report mode indicating at least one of a wideband report or a subband report and information on a compression mode indicating a compression ratio.

The at least one processor may be further configured to transmit, to the base station, information indicating whether to independently compress channels for which the terminal has performed AI-based channel prediction, or compress the channels in combination.

The at least one processor may be further configured to identify whether to change the AI-based CSI feedback mode, based on a channel estimation result, and transmit, to the base station, an AI-based CSI feedback mode preferred by the terminal or a parameter corresponding to the AI-based CSI feedback mode preferred by the terminal, based on a result of the identification.

As described above, a base station in a wireless communication system may include at least one transceiver, and at least one processor functionally coupled to the at least one transceiver, wherein the at least one processor is configured to receive, from a terminal, an AI-based CSI feedback mode supported by an AI model of the terminal and capability information corresponding to the CSI feedback mode, wherein the AI-based CSI feedback mode supported by the AI model of the terminal includes at least one of an AI-based channel prediction mode or an AI-based CSI compression mode, identify an indicator indicating a CSI feedback mode performed by the terminal and configuration information corresponding to the CSI feedback mode performed by the terminal, based on the received capability information, transmit, to the terminal, the indicator indicating the CSI feedback mode performed by the terminal and the configuration information corresponding to the CSI feedback mode performed by the terminal, and receive, from the terminal, CSI generated based on the transmitted configuration information and a CSI-RS.

Herein, when the AI-based CSI feedback mode supported by the AI model of the terminal includes the AI-based channel prediction mode, the configuration information corresponding to the CSI feedback mode performed by the terminal may include information on a prediction interval and information on the number of prediction time-steps.

In addition, when the AI-based CSI feedback mode supported by the AI model of the terminal includes the AI-based CSI compression mode, the configuration information corresponding to the CSI feedback mode performed by the terminal may include information on a report mode indicating at least one of a wideband report or a subband report and information on a compression mode indicating a compression ratio.

The at least one processor may be further configured to receive, from the terminal, information indicating whether to independently compress channels for which the terminal has performed AI-based channel prediction, or compress the channels in combination.

The at least one processor may be further configured to identify whether to change the AI-based CSI feedback mode, based on the number of terminals connected to the base station or performance of the AI model included in the terminal, and transmit, to the terminal, an indicator indicating a CSI feedback mode to be changed and configuration information corresponding to the CSI feedback mode to be changed, based on a result of the identification.

The methods according to embodiments described in the disclosure may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program may include instructions that cause the electronic device to perform the methods according to various embodiments of the disclosure as defined by the appended claims and/or disclosed herein.

The programs (software modules or software) may be stored in non-volatile memories including a random access memory and a flash memory, a read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Alternatively, any combination of some or all of the devices may form a memory in which the program is stored. A plurality of such memories may be included in the electronic device.

In addition, the programs may be stored in an attachable storage device which may access the electronic device through communication networks such as the Internet, Intranet, local area network (LAN), Wide LAN (WLAN), and storage area network (SAN) or a combination thereof. Such a storage device may access the electronic device via an external port. Furthermore, a separate storage device on the communication network may access a portable electronic device.

While the disclosure has been illustrated and described with reference to various embodiments of the present disclosure, those skilled in the art will understand that various changes can be made in form and detail without departing from the spirit and scope of the present disclosure as defined by the appended claims and their equivalents.

What is claimed is:

1. A method performed by a user equipment (UE) in a wireless communication system, the method comprising:
transmitting, to a base station, an artificial intelligence (AI)-based channel state information (CSI) feedback mode supported by an AI model of the UE and capability information corresponding to the CSI feedback mode, the AI-based CSI feedback mode including at least one of an AI-based channel prediction mode or an AI-based CSI compression mode;
receiving, from the base station, an indicator indicating the CSI feedback mode performed by the UE and configuration information corresponding to the CSI feedback mode performed by the UE;
generating CSI, based on the received configuration information and a CSI-reference signal (CSI-RS); and
transmitting the generated CSI to the base station.

2. The method of claim 1,
wherein in case that the AI-based CSI feedback mode supported by the AI model of the UE comprises the AI-based channel prediction mode, the configuration information corresponding to the CSI feedback mode performed by the UE comprises information on a prediction interval and information on a number of prediction times and prediction steps.

3. The method of claim 1,
wherein in case that the AI-based CSI feedback mode supported by the AI model of the UE comprises the AI-based CSI compression mode, the configuration information corresponding to the CSI feedback mode performed by the UE comprises information on a report mode indicating at least one of a wideband report or a subband report and information on a compression mode indicating a compression ratio.

4. The method of claim 1, further comprising:
transmitting, to the base station, information indicating whether to independently compress channels for which the UE has performed AI-based channel prediction, or to compress the channels in combination.

5. The method of claim 1, further comprising:
identifying whether to change the AI-based CSI feedback mode, based on a channel estimation result; and
transmitting, to the base station, an AI-based CSI feedback mode preferred by the UE or a parameter corresponding to the AI-based CSI feedback mode preferred by the UE, based on a result of the identification.

6. A method performed by a base station in a wireless communication system, the method comprising:
receiving, from a user equipment (UE), an artificial intelligence (AI)-based channel state information (CSI) feedback mode supported by an AI model of the UE and capability information corresponding to the CSI feedback mode, the AI-based CSI feedback mode including at least one of an AI-based channel prediction mode or an AI-based CSI compression mode;
identifying an indicator indicating a CSI feedback mode performed by the UE and configuration information corresponding to the CSI feedback mode performed by the UE, based on the received capability information;
transmitting, to the UE, the indicator indicating the CSI feedback mode performed by the UE and the configuration information corresponding to the CSI feedback mode performed by the UE; and
receiving, from the UE, CSI generated based on the transmitted configuration information and a CSI-reference signal (CSI-RS).

7. The method of claim 6,
wherein in case that the AI-based CSI feedback mode supported by the AI model of the UE comprises the AI-based channel prediction mode, the configuration information corresponding to the CSI feedback mode performed by the UE comprises information on a prediction interval and information on a number of prediction times and a number of steps.

8. The method of claim 6,
wherein in case that the AI-based CSI feedback mode supported by the AI model of the UE comprises the AI-based CSI compression mode, the configuration information corresponding to the CSI feedback mode performed by the UE comprises information on a report mode indicating at least one of a wideband report or a subband report and information on a compression mode indicating a compression ratio.

9. The method of claim 6, further comprising:
receiving, from the UE, information indicating whether to independently compress channels for which the UE has performed AI-based channel prediction, or compress the channels in combination.

10. The method of claim 6, further comprising:
identifying whether to change the AI-based CSI feedback mode, based on a number of UEs connected to the base station or performance of the AI model included in the UE; and
transmitting, to the UE, an indicator indicating a CSI feedback mode to be changed and configuration information corresponding to the CSI feedback mode to be changed, based on a result of the identifying of whether to change the AI-based CSI feedback mode.

11. A user equipment (UE) in a wireless communication system, the UE comprising:
a transceiver; and
a controller coupled with the transceiver, and configured to:
transmit, to a base station, an artificial intelligence (AI)-based channel state information (CSI) feedback mode supported by an AI model of the UE and capability information corresponding to the CSI feedback mode, the AI-based CSI feedback mode including at least one of an AI-based channel prediction mode or an AI-based CSI compression mode,
receive, from the base station, an indicator indicating a CSI feedback mode performed by the UE and configuration information corresponding to the CSI feedback mode performed by the UE,
generate CSI, based on the received configuration information and a CSI-reference signal (CSI-RS), and
transmit the generated CSI to the base station.

12. The UE of claim 11,
wherein in case that the AI-based CSI feedback mode supported by the AI model of the UE comprises the AI-based channel prediction mode, the configuration information corresponding to the CSI feedback mode performed by the UE comprises information on a prediction interval and information on a number of prediction times and steps.

13. The UE of claim 11,
wherein in case that the AI-based CSI feedback mode supported by the AI model of the UE comprises the AI-based CSI compression mode, the configuration information corresponding to the CSI feedback mode performed by the UE comprises information on a report mode indicating at least one of a wideband report or a subband report and information on a compression mode indicating a compression ratio.

14. The UE of claim 11,
wherein the controller is further configured to transmit, to the base station, information indicating whether to independently compress channels for which the UE has performed AI-based channel prediction, or compress the channels in combination.

15. The UE of claim 11, wherein the controller is further configured to:
identify whether to change the AI-based CSI feedback mode, based on a channel estimation result, and
transmit, to the base station, an AI-based CSI feedback mode preferred by the UE or a parameter corresponding to the AI-based CSI feedback mode preferred by the UE, based on a result of the identification of whether to change the AI-based CSI feedback mode.

16. A base station in a wireless communication system, the base station comprising:
a transceiver; and
a controller coupled with the transceiver, and configured to:
receive, from a user equipment (UE), an artificial intelligence (AI)-based channel state information (CSI) feedback mode supported by an AI model of the UE and capability information corresponding to the CSI feedback mode, the AI-based CSI feedback mode including at least one of an AI-based channel prediction mode or an AI-based CSI compression mode,
identify an indicator indicating a CSI feedback mode performed by the UE and configuration information corresponding to the CSI feedback mode performed by the UE, based on the received capability information,
transmit, to the UE, the indicator indicating the CSI feedback mode performed by the UE and the configuration information corresponding to the CSI feedback mode performed by the UE, and
receive, from the UE, CSI generated based on the transmitted configuration information and a CSI-reference signal (CSI-RS).

17. The base station of claim 16,
wherein in case that the AI-based CSI feedback mode supported by the AI model of the UE comprises the AI-based channel prediction mode, the configuration information corresponding to the CSI feedback mode performed by the UE comprises information on a prediction interval and information on a number of prediction times and steps.

18. The base station of claim 16,
wherein in case that the AI-based CSI feedback mode supported by the AI model of the UE comprises the AI-based CSI compression mode, the configuration information corresponding to the CSI feedback mode performed by the UE comprises information on a report mode indicating at least one of a wideband report or a subband report and information on a compression mode indicating a compression ratio.

19. The base station of claim 16,
wherein the controller is further configured to receive, from the UE, information indicating whether to independently compress channels for which the UE has performed AI-based channel prediction, or compress the channels in combination.

20. The base station of claim 16, wherein the controller is further configured to:
identify whether to change the AI-based CSI feedback mode, based on a number of UEs connected to the base station or performance of the AI model included in the UE, and
transmit, to the UE, an indicator indicating a CSI feedback mode to be changed and configuration information corresponding to the CSI feedback mode to be changed, based on a result of the identification.
